(19) United States
(12) Patent Application Publication
(10) Pub. No.: US 2009/0200818 A1
(43) Pub. Date: Aug. 13, 2009

(54) Retention System and Cover for This With an Integrated Retention Function

(75) Inventors: Hans-Gerhard Giesa, Hamburg (DE); Thomas Rathmann-Ramlow, Ense (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Airbus Deutschland GmbH, Hamburg (DE)

(21) Appl. No.: 11/887,606

(22) PCT Filed: Mar. 30, 2006
(86) PCT No.: PCT/EP2006/002898

§ 371 Date: Apr. 6, 2009

Related U.S. Application Data
(60) Provisional application No. 60/667,566, filed on Apr. 1, 2005.

(30) Foreign Application Priority Data
Apr. 1, 2005 (DE) 10 2005 014 997.9

(51) Int. Cl. B60R 21/02; A44B 21/00

(52) U.S. Cl. 296/1.04; 24/593.1

(57) ABSTRACT

A retention system with a cover (3), which includes at least one attachment element (6), by means of which the cover (3) can be attached to a seat (2) for the restraint of a passenger covered with the cover (3) by two-dimensional absorption of force by means of the cover (3).

### REFERENCE TO RELATED APPLICATIONS

This application claims the benefit of the filing date of German Patent Application No. 10 2005 014 997.9 filed Apr. 1, 2005 and of U.S. Provisional Patent Application No. 60/667,556 filed Apr. 1, 2005, the disclosure of which applications is hereby incorporated herein by reference.

### FIELD OF THE INVENTION

The present invention relates to a cover and to a retention system, in particular a cover with an integrated retention function, which can be used in the retention system and, for example, can be applied to reclining seats in an aircraft.

### TECHNOLOGICAL BACKGROUND

On long-haul flights seats are often used in the aircraft cabins whose backrests can be inclined so far backwards that the passengers are in a reclining, or near-reclining position. To safeguard the passengers from injuries as a result of sudden accelerations two-point seat belts are generally used. The use of the belts is prescribed during certain phases of the flight (for example, takeoff and landing). Also when turbulence is anticipated the so-called Fasten Seat Belt Sign is activated and the belts must be applied. The conventional two-point seat belts are however only optimised for utilisation with an upright backrest.

In the event of sudden onset of turbulence or sudden flight manoeuvres sleeping passengers, in particular, are not always secured by means of belts. Preventative safeguarding by means of belts is often perceived as being uncomfortable.

### SUMMARY OF THE INVENTION

Amongst other things, it may be an object of the invention is to provide a realisation which is adapted to protect passengers whose sitting position is not upright from injuries, in the event of sudden onset of turbulence or sudden unexpected flight manoeuvres, without impairing passenger comfort.

The achievement of this object may be taken from the independent patent claims. Further embodiments of the invention are specified in the subsidiary claims.

In accordance with the invention a cover with an integrated retention function is created for a passenger, which can be used in a retention system. The cover has, for example, a warming function. The retention system consists, for example, of the cover and a seat. The seat is, for example, configured such that its backrest can be inclined far backwards (e.g. sleeper seats, flat bed seats, lie-flat seats). The term “seat” as used here includes also a bed, which, for example, can be used for the transport of people who are ill, and in the following paragraphs is also designated as a reclining seat. The cover is preferably manufactured from a breathable material of sufficient strength, and includes provisions for the attachment of a “hygiene cover”, which can be changed after each use. The cover is, for example, attached by means of an attachment element or similar attachment parts (for example a fastening tongue) to the passenger seat. The attachment between cover and seat can be released non-destructively. The restraint of a passenger is achieved by a two-dimensional or plane absorption of force by the cover. The cover comes into use, in particular, if the passenger seat in question is moved into the reclining position, during the night, for example. By means of additional fittings the restraint cover can also, on occasion, enable the transport of persons reclining during takeoff and landing also.

Furthermore the cover provides sufficient freedom of movement in the shoulder zone such that passenger comfort is preserved or improved. Such freedom of movement can, for example, be achieved by using, at least in the shoulder zone of the cover, a woven fabric with sufficient extensibility.

In accordance with another exemplary embodiment of the invention freedom of movement can be achieved by forming the cover from a very stiff, essentially non-extensible material and achieving the freedom of movement in the shoulder zone such that the cover is attached via an attachment element fitted to the cover, for example a fastening tongue, with a belt retraction device with a locking function fitted to the passenger seat, which has a retracted retention belt with limiter. The belt retraction device includes, for example, a centrifugal clutch, which in the event of an unexpected flight manoeuvre prevents any reeling out of the belt, whereby the passenger may be securely restrained.

If the locking function is not triggered the retracted belt can be freely reeled in and out, whereby freedom of movement in the shoulder zone is ensured.

Furthermore a combination of an extensible cover and the belt retraction device with the retention belt is also possible.

In order to improve further the retention function of the cover a belt can, for example, be used that runs diagonally across the cover. For example, two inelastic or partially elastic belts running in a cruciform manner can improve the retention function of the cover. The belts can also be worked into the cover.

In accordance with a further embodiment of the invention a correct attachment of the cover to the passenger seat (reclining seat) can be established by a sensor (for example a switch) integrated either in the attachment element of the cover, or in the fastening element fitted to the passenger seat, by means of an appropriate indication (for example LED lamps) on the attachment element, or on the fastening element.

In accordance with another embodiment the attachment status of the covers of the whole aircraft cabin can be presented on a display unit at a central location (for example on the flight attendants' panel).

The invention provides an option to protect reclining passengers from injuries in the event of sudden onset of turbulence, or sudden unexpected flight manoeuvres, without impairing passenger comfort.

Herein, the cover fulfils a dual function. It serves on the one hand as a cover for sleeping passengers, and on the other hand, at the same time, as a retention system. By the use of the cover passengers are permanently secured, even at times when the “Fasten Seat Belt Sign” is not activated. In this way the passengers are also protected in the event of unexpected turbulence.

By means of the two-dimensional or planar mode of action the elastic cover enables sufficient freedom of movement (e.g. the person can turn over under the cover) and is essentially more comfortable than the conventional belt solution. The use of retractors can be avoided. Manual operation is simple and monitoring of correct attachment is supported by means of the indication function.

### SHORT DESCRIPTION OF THE DRAWING

In the following paragraphs exemplary embodiment of the invention are described with reference to the accompanying drawings.

In the drawings:

FIG. 1 shows a schematic perspective view of a retention system with cover according to a first exemplary embodiment;

FIG. 2 shows a schematic detail view of the attachment zone of the cover according to FIG. 1;

FIG. 3 shows a schematic part side view of a retention system according to a second exemplary embodiment;

FIG. 4 shows a schematic plan view of a cover in accordance with the invention; and

FIG. 5 shows a schematic view of a fastening element, which is used in the exemplary embodiments of the invention.

In the following paragraphs the same reference numbers are used to identify the same elements and components in the figures in the different views.

### DETAILED DESCRIPTION OF EXEMPLARY EMBODIMENTS

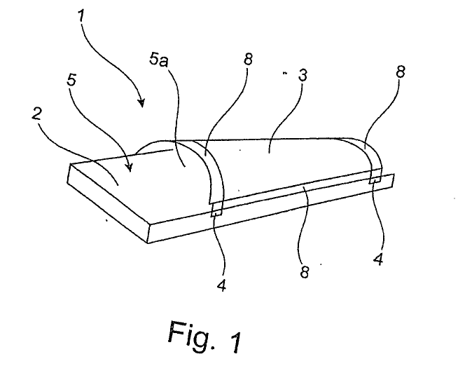

FIG. 1 shows a schematic perspective view of a retention system 1 in accordance with the invention. The retention system 1 includes a reclining seat 2, which is a passenger seat of general known art, which can be moved into the reclining position, as shown in FIG. 1.

The retention system 1 furthermore includes a cover 3, which is attached securely in the attachment zones 4 to the reclining seat 2.

According to embodiment shown in FIG. 1, the head zone 5 of the reclining seat 2 is not covered by the cover 3 and in the shoulder zone a sufficient freedom of movement for a covered passenger (not shown) is ensured.

As furthermore shown in FIG. 1, the cover 3 includes an edge band 8 that runs around the boundary. The edge band 8 is preferably of a stable tearproof material.

Although in FIG. 1 only two attachment zones are to be seen, any number of attachment zones 4 can be provided, at which the cover 3 is attached to the reclining seat 2, in order to restrain a covered person securely.

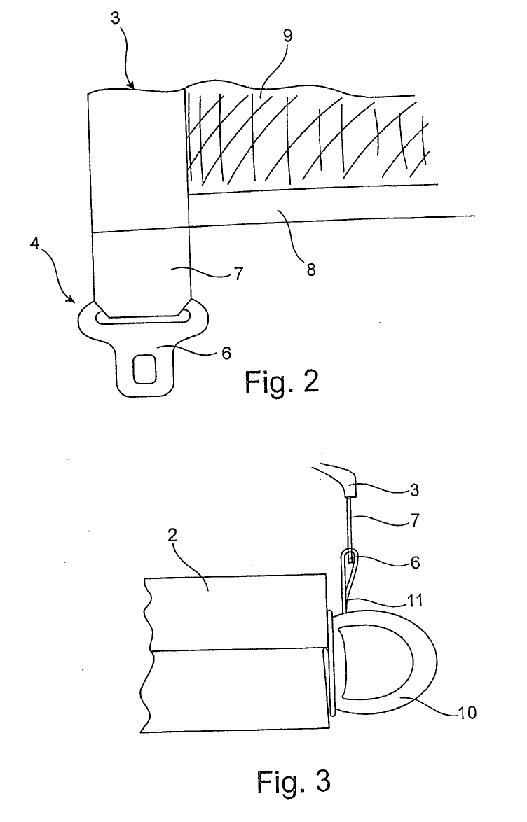

In the following paragraphs the attachment zone 4 of the cover 3 is described in more detail with reference to FIG. 2.

FIG. 2 shows a schematic detail view of the cover 3 in the attachment zone 4 according to FIG. 1;

As shown in FIG. 2, the cover 3 includes in the attachment zone 4 a fastening tongue 6, which is attached via a strap 7 with the cover 3. The fastening tongue can, for example, be attached to a belt buckle, which may be attached to the reclining seat. Such a belt buckle is described in more detail with reference to FIG. 5.

The strap is preferably attached to a peripheral edge band 8 of a tearproof material and can, for example, be fixed with adhesive or sewn to the peripheral edge band 8.

Alternatively the edge band 8 and the strap 7 can also be integrally configured as one item.

As shown in FIG. 2, in a zone adjoining the edge band 8 the coyer 3 includes a woven fabric 9, which preferably consists of an elastic material. This elastic woven fabric ensures, for example, a sufficient freedom of movement in the shoulder zone.

In accordance with another exemplary embodiment the woven fabric 9 does not need to be elastic and in this case another appropriate measure can be encountered to ensure a sufficient freedom of movement in the shoulder zone, as, for example, shown in FIG. 3.

FIG. 3 shows a retention system in accordance with the second example of embodiment of the invention in a schematic part view from the side.

FIG. 3 shows the cover 3 in conjunction with a belt retraction device 10. The belt retraction device 10 is, for example, in accordance with this embodiment attached securely to the reclining seat 2 (for example at the side). The belt retraction device 10 includes a retracted belt 11, one end of which projects out of the belt retraction device 10 in FIG. 3.

The end of the belt 11 projecting out of the belt retraction device 10 is, for example, attached to the cover 3 via an appropriately configured attachment device. Although not shown in detail in FIG. 3, for example, the end of the belt 11 projecting out of the belt retraction device 10 can be fitted with a belt buckle, as is later described with reference to FIG. 5, where for the secure attachment of the cover 3 the fastening tongue 6 shown in FIG. 2 is engaged in this belt buckle. Other suitable attachment devices that ensure an attachment that can be released are possible.

In the exemplary embodiment shown in FIG. 3, the cover 3 does not need to include an elastic woven fabric 9, as shown in FIG. 2, since by virtue of the belt retraction device 10 the belt 11 can be flexibly reeled in and out, whereby a sufficient degree of freedom in the shoulder zone may be ensured. Combinations of the examples of embodiment according to FIG. 2 and FIG. 3 are possible.

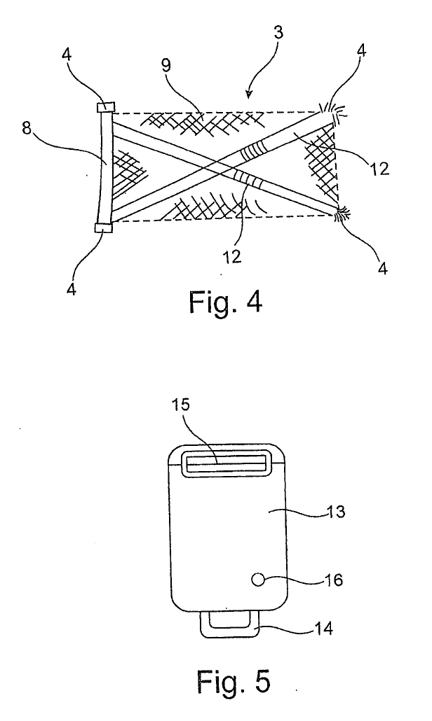

FIG. 4 shows a schematic plan view of a cover 3, which can be used both in the first example of embodiment and also in the second example of embodiment.

To support the retention function of the cover 3, the cover 3 includes belts 12, preferably running diagonally.

The belts 12 end, for example, in the attachment zones 4 of the cover 3 and are, for example, formed of the same material as the edge band 8.

The edge band and the belts 12 can, for example, be formed in one piece or can be fixed with adhesive, welded, sewn, etc to each other. Although in FIG. 4 two belts 12 are shown running in a cruciform manner, only one diagonal or otherwise running belt can also be used, or more than two belts can be used.

FIG. 5 shows a schematic side view of a fastening element. The fastening element is, for example, a conventional belt buckle 13, that via an attachment zone 14 is attached to a reclining seat. The belt buckle 13 has an opening 15 at its end that is opposite to the attachment zone 14, in which, for example, the fastening tongue shown in FIG. 2 can be engaged, whereby the fastening tongue 6 and the belt buckle 13 are attached securely to one another. A pushbutton, not shown in FIG. 5, can enable a release of the attachment between the belt buckle 13 and the fastening tongue 6 at any time.

As is furthermore shown in FIG. 5, the belt buckle 13 includes a display element 16, for example an LED, in order to indicate an attachment between the belt buckle 13 and the fastening tongue 6. In accordance with the preferred example of embodiment the LED 16 lights up, for example, if an attachment between the fastening tongue 6 and the belt buckle 13 is present.

Although the invention in the preceding paragraphs has been described with reference to exemplary embodiments modifications and alterations can be undertaken without leaving the scope of protection of the invention. For example, other attachment devices can be used to attach the cover in accordance with the invention to the passenger seat, as long as it is ensured that a passenger covered with the cover is restrained by the cover by two-dimensional absorption of force if, for example, unexpected turbulence occurs.

### REFERENCE LIST

1 Retention system
2 Reclining seat
3 Cover
4 Attachment zone
5 Head zone
5a Shoulder zone
6 Fastening tongue
7 Strap
8 Edge band
9 Woven fabric
10 Belt retraction device
11 Belt
12 Belt
13 Belt buckle
14 Zone
15 Opening
16 Indication element

1. A cover comprising at least one attachment element to attach the cover to a seat for the restraint of a passenger covered with the cover by two-dimensional absorption of force by the cover.

2. The cover according to claim 1,
wherein the attachment element can be released non-destructively.

3. The cover according to claim 1,
wherein the attachment element is configured as a fastening tongue.

4. The cover according to claim 3,
wherein the fastening tongue is attached to the cover by a strap.

5. The cover according to claim 1,
wherein the cover is formed, at least in the shoulder zone, from an extensible woven fabric.

6. The cover according to claim 1,
wherein the retention function of the cover is reinforced by at least one diagonally running retention belt.

7. A retention system comprising a cover according to claim 1,
wherein the attachment element fitted to the cover is configured to be attached to a fastening element fitted to a reclining seat to attach the cover to the reclining seat.

8. The retention system according to claim 7,
wherein the fastening element is configured as a belt buckle that is fitted securely to a reclining seat, in which the fastening tongue can be introduced to attach the cover to the reclining seat.

9. The retention system according to claim 7,
wherein the fastening element is configured as a belt retraction device with locking function that is fitted securely to a reclining seat, for the reeling in or out of a belt, which can be attached to the cover, for the retention of a passenger covered with the cover, by engagement of the belt.

10. The retention system according to claim 9,
wherein an end of the belt projecting out of the belt retraction device includes a belt buckle, which is configured to be attached via the fastening tongue with the cover.

11. The retention system according to claim 7,
wherein the fastening element is associated with a display element configured for indication of an attachment of the cover to the reclining seat.

12. The retention system according to claim 11,
wherein the display element indicates whether the fastening tongue and the fastening element are attached to each other.

13. The retention system according to claim 11,
wherein the display element is integrated into the fastening element.

14. The retention system according to claims 10,
wherein the indication takes place on a central display unit.

15. (canceled)
